(19) United States
(12) Patent Application Publication
(10) Pub. No.: US 2023/0030663 A1
(43) Pub. Date: Feb. 2, 2023

(54) METHOD FOR DETERMINING THE POSITION AND/OR THE SPEED OF AN ELECTRIC MACHINE ROTOR BY PROCESSING THE SIGNALS OF A POSITION SENSOR

(71) Applicant: IFP Energies nouvelles, RUEIL-MALMAISON (FR)

(72) Inventors: Ngoc-Tu TRINH, RUEIL-MALMAISON CEDEX (FR); Fabien VIDAL-NAQUET, RUEIL-MALMAISON CEDEX (FR)

(21) Appl. No.: 17/785,169

(22) PCT Filed: Dec. 9, 2020
(86) PCT No.: PCT/EP2020/085206

§ 371 Date: Jun. 14, 2022

(30) Foreign Application Priority Data
Dec. 17, 2019 (FR) FR1914641

(51) Int. Cl. H02P 21/18; H02P 21/13

(52) U.S. Cl. CPC H02P 21/18; H02P 21/13

(57) ABSTRACT

The invention determines at least one of the angular speed and the angular position of a rotor of an electric machine through determination of the harmonics, using a closed loop comprising a harmonic observer, phase difference correction and a first phase-locked loop that estimates the position of the rotor.

Reference is made to PCT/EP2020/085206 filed Dec. 9, 2020, designating the United States, and French Application No. 19/14.641 filed Dec. 17, 2019, which are incorporated herein by reference in their entirety.

### BACKGROUND OF THE INVENTION

### Field of the Invention

The present invention relates to the field of determining the position and/or the speed of a rotor of an electric machine.

### Description of the Prior Art

Precise knowledge of at least one of the angular position and the angular speed of an electric machine rotor is useful notably for controlling and monitoring electric machines. Indeed, at least one of rotor position and speed is often essential data for controlling such electric machines, notably for controlling at least one of the torque and the rotational speed thereof.

There is a wide variety of position sensors that have been developed for this application, including notably magnetostrictive sensors, encoders, solvers, GMR (Giant MagnetoResistance) sensors, and inductive sensors. Such sensors can generate two signals with a first signal of cosine wave type and a second signal of sine wave type, from which at least one of the rotor position and speed are reconstructed.

Ideally, these signals should have the same amplitude, no offset, and they should be orthogonal (with a phase difference strictly equal to 90°). However, these signals may comprise harmonics which, upon reconstruction of at least one of the rotor position and speed, can generate significant inaccuracies for rotor position or speed determination. Moreover, there may also be a phase difference between these two signals (due to the position of the position sensor for example), which may also generate an error when determining the rotor position or speed. These inaccuracies and errors have a significant impact on electric machine control or electric machine monitoring. Indeed, an error in the rotor position can for example generate an unsuitable torque setpoint for use of the electric machine, or torque harmonics, etc.

In order to limit the impact of harmonics and of phase difference, several technical solutions have been developed.

For example, patent application DE-102,014,226,604 describes a method of correcting the angular position of the rotor. This method uses the measurement of two position sensors arranged at 90° to each other around the rotor, and provides an estimation of a correction value depending on the phase difference of the signals from the two position sensors. However, this method only allows the phase difference to be corrected, but not the harmonics.

Patent application DE102,016,220,188 describes a method of correcting rotation sensor measurements generating sine and cosine signals, by use of static correction and dynamic correction. Static correction is based on charts and dynamic correction is intended to take into account the amplitude difference between the signals and the offset differences. However, this method does not enable continuous correction of the harmonics. Additionally, using charts may not provide optimal correction and requires preparing complex charts that may notably depend on the rotational speed and the load of the electric machine.

Published US patent application 2019/0,031,046 relates to the elimination of offset in signals measuring the position of an electric machine. This method is based on the addition and the subtraction of signals and on the use of integrators by use of a motion state filter. This method therefore allows to eliminate only offsets and does not determine and eliminate harmonics.

### SUMMARY OF THE INVENTION

The present invention determines the speed and the position of a rotor in a precise and errorless manner. The invention relates to a method of determining at least one of the angular speed and the angular position of a rotor of an electric machine through determination of the harmonics, using a closed loop comprising a harmonic observer, phase difference correction and a first phase-locked loop that estimates the position of the rotor.

Furthermore, the invention relates to a method of determining at least one of the speed and the position of an electric machine rotor by precisely determining the harmonics, through continuous correction of the measurement signals only when the harmonic observer is convergent, the corrected signals are used to determine at least one of the position and the speed of the rotor. Determination of the harmonics is performed using a closed loop comprising a harmonic observer, phase difference correction, and a first phase-locked loop that estimates the position of the rotor.

The invention relates to a method of determining at least one of the position and the speed of an electric machine rotor by use of a sensor that determines the position of the rotor The position sensor generates a cosine signal and a sine signal. This method utilizes a closed loop comprising a harmonic state observer, correction of the phase difference of the generated cosine and sine signals and a first phase-locked loop PLL. The state observer of the harmonics relates the generated cosine and sine signals and a value of the rotor position estimated is by the first phase-locked loop PLL to the harmonics. The correction of the phase difference identifies and corrects the phase difference of the generated cosine and sine signals by use of the harmonics determined by the state observer of the harmonics, and the first phase-locked loop PLL estimates at least one of the position and the speed of the rotor from the corrected cosine and sine signals.

According to one embodiment, the following steps are carried out:

a) determining the harmonics of the generated cosine and sine signals by use of the closed loop comprising the state observer of the harmonics, the correction of the phase difference of the generated cosine and sine signals, and the first phase-locked loop PLL;

b) determining whether the state observer of the harmonics is convergent;

c) continuously correcting the generated cosine and sine signals by updating the determined harmonics when the state observer of the harmonics is convergent; and

d) determining at least one of the position and the speed of the rotor by use of a second phase-locked loop PLL from the corrected cosine and sine signals.

Advantageously, convergence of the state observer of the harmonics is determined by verifying the equation:

\sqrt{|yₐ−ŷₐ|²+|y_{b}−ŷ_{b}|²}<ε

with yₐ and y_{b} being the generated cosine and sine signals, ŷₐ and ŷ_{b} being signals reconstructed by use of the estimated position and ε being a predetermined threshold.

Preferably, the first and second phase-locked loops PLL comprise a proportional integral controller and an integrator.

Advantageously, the transfer function of the first and second phase-locked loops PLL is written as follows:

$$\frac{\hat{θ} ( s )}{θ ( s )} = \frac{1 + \frac{{K}_{p}}{{K}_{i}} * s}{1 + \frac{{K}_{p}}{{K}_{i}} * s + \frac{1}{{K}_{i}} * {s}^{2}}$$

with θ being the position of the rotor, \hat{θ} being the estimated position of the rotor, s the being Laplace parameter, Kₚ being the proportional coefficient of the proportional integral controller and Kᵢ being the integral coefficient of the proportional integral controller.

According to one implementation, the integral coefficient Ki of the first phase-locked loop is less than the integral coefficient Ki of the second phase-locked loop.

According to one aspect, the cosine and sine signals are corrected by filtering the determined harmonics and possibly by correcting the phase difference of the cosine and sine signals.

According to one feature, the state observer of the harmonics involves a transfer function expressed as:

$$\frac{{\hat{y}}_{k}}{y} = \frac{\frac{α * s}{{s}^{2} + {( k * ω )}^{2}}}{1 + {\sum }_{k = 0 \to n} \frac{α * s}{{s}^{2} + {( k * ω )}^{2}}}$$

with s being the Laplace parameter, a being again, k being the order of the harmonic being considered, n being the number of harmonics of the cosine and sine signals, w being a fundamental frequency, y being a generated signal considered among the cosine and sine signals, and ŷₖ being the estimated harmonic of order k of the generated signal considered among the cosine and sine signal.

According to one embodiment, the gain a is less than the fundamental frequency, preferably the gain a is less than one tenth of the fundamental frequency ω.

According to one embodiment, the state observer of the harmonics further determines the fundamental coefficients of the harmonics and the offsets of the generated cosine and sine signals.

According to an implementation, the phase difference between the generated cosine and sine signals is identified by means of the fundamental coefficients of the harmonics using an arctangent function.

Advantageously, the phase difference ϕ between the generated cosine and sine signals is determined by use of the equation:

$$ϕ = atan ( \frac{{L}_{1 b} * sin ( ϕ )}{{L}_{1 b} * cos ( ϕ )} )$$

$$with$$

$${L}_{1 b} * sin ( ϕ ) = - {\hat{L}}_{11 b} * cos ( Δθ ) - {\hat{L}}_{12 b} * sin ( Δθ )$$

$${L}_{1 b} * cos ( ϕ ) = {\hat{L}}_{12 b} * cos ( Δθ ) - {\hat{L}}_{11 b} * sin ( Δθ )$$

and with L_{1b} being the fundamental coefficient of one of the generated cosine and sine signals, \hat{L}_{11b} and \hat{L}_{12b} the being fundamental coefficients determined by the state observer of the harmonics, Δθ being the difference between the measured position of the rotor and the position of the rotor estimated by the first phase-locked loop PLL.

According to an embodiment, the phase difference of one of the generated cosine and sine signals is corrected by use of the equation:

$${y}_{fb - correction} = {L}_{1 b} * \frac{{y}_{fb} - \frac{{y}_{fa}}{{L}_{1 a}} * ( {L}_{1 b} * sin ( Φ ) )}{( {L}_{1 b} * cos ( Φ ) )}$$

with y_{fb-correction} being the fundamental of the corrected generated signal of one of the generated cosine and sine signals, L₁ₐ and L_{1b} being the fundamental coefficients of the generated cosine and sine signals, y_{fa} and y_{fb} being the fundamentals of the measured generated cosine and sine signals, and ϕ being phase difference.

According to an aspect, the position sensor is one of a magnetostrictive sensor, an inductive sensor, an encoder, a GMR sensor, an AMR sensor, a TMR sensor or a solver.

Furthermore, the invention relates to a method of controlling an electric machine, the electric machine comprising a sensor that determines the position of the rotor of the electric machine, the position sensor generating a cosine signal and a sine signal, wherein the following steps are carried out:

a) determining at least one of position and the speed of the rotor by use of the method according to one of the above features and the signals generated by the position sensor; and

b) controlling the electric machine according to the at least one of predetermined position and/or the predetermined speed.

### BRIEF DESCRIPTION OF THE FIGURES

Other features and advantages of the method according to the invention will be clear from reading the description hereafter of embodiments given by way of non-limitative example, with reference to the accompanying figures wherein:

FIG. 1 illustrates the steps of the method according to a first embodiment of the invention;

FIG. 2 illustrates the steps of the method according to a second embodiment of the invention;

FIG. 3 illustrates the construction of a phase-locked loop according to an embodiment of the invention;

FIG. 4 illustrates the reference rotational speed for an application example of the method according to the invention;

FIG. 5 illustrates the rotational speed determined with the method according to an embodiment of the invention for the application example of FIG. 4; and

FIG. 6 illustrates the position error between the reference position and the position determined with the method according to an embodiment for the application example of FIG. 4.

### DETAILED DESCRIPTION OF THE INVENTION

The present invention relates to the determination of the position of a rotor of an electric machine. The electric machine is provided with an angular position sensor that generates a cosine signal and a sine signal while measuring. In the rest of the description, these two signals are referred to as measurement signals Moreover, in the rest of the description, what is referred to as position is the angular position of the rotor and what is referred to as speed is the angular speed of the rotor. The present invention is suited for any electric machine whose position is to be measured. The present invention is particularly suited for permanent magnet-assisted synchronous reluctance machines that are very sensitive to position measurement.

The position sensor can be selected from among magnetostrictive sensors, inductive sensors, encoders and solvers, a GMR sensor (based on Giant MagnetoResistance), an AMR sensor (based on Anisotropic MagnetoResistance), a TMR sensor (based on Tunnel effect MagnetoResistance) or any other sensor capable of generating a cosine measurement signal and a sine measurement signal.

What is referred to as harmonic is a primary decomposition element of a periodic function, here the periodic function corresponds to the measurement signals. What is referred to as fundamental is the harmonic of first order of the measurement signals, that is the first harmonic. What is referred to as offset is the continuous offset of the measurement signals.

Preferably, the method according to the invention can use a single position sensor, thus limiting inaccuracies related to the multiplication of sensors and to the difficulty in precisely positioning several sensors.

According to a first embodiment, the method may use a closed loop allowing to determine the harmonics of the measurement signals and to deduce therefrom at least one of the position and the speed of the rotor. The closed loop is described in detail in connection with step 1 in the rest of the description. The steps of the closed loop can be carried out by a computer system or an electronic system, notably a computer or electronic system that controls the electric machine.

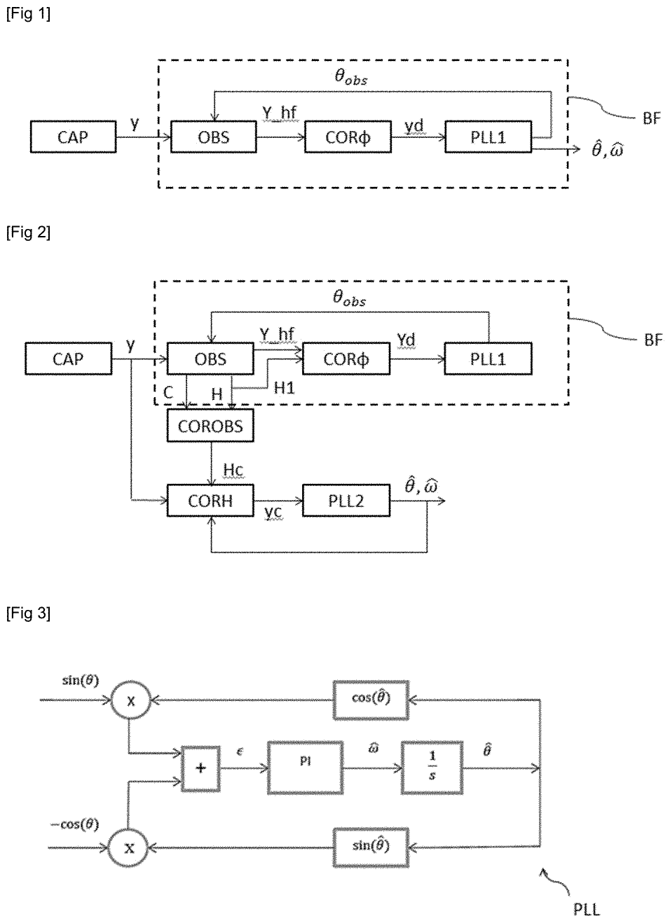

FIG. 1 schematically illustrates, by way of non-limitative example, the steps of the method according to the first embodiment of the invention. The position sensor CAP first generates measurement signals y. The harmonics of the measurements are then determined by use of a closed loop BF, which comprises a harmonic state observer OBS, a phase difference corrector CORD and a first phase-locked loop PLL1. Harmonic state observer OBS determines the harmonics from measurement signals y and from the rotor position Gobs estimated by first phase-locked loop PLL1. Harmonic state observer OBS also determines signals y_hf formed by the suppression of the harmonics of order strictly greater than 1 from measurement signals y. Phase difference corrector CORD identifies and corrects the phase difference, as well as the offset and the amplitudes of measurement signals y_hf to form a corrected signal yd from the identified harmonics. First phase-locked loop PLL1 estimates an estimated rotor position Gobs from corrected signal yd. For this first embodiment, at least one of the estimated rotor position and speed are obtained by first phase-locked loop PLL1.

The method according to the second embodiment of the invention comprises the following steps:

1) Determination of harmonics;

2) Determination of the harmonic observer convergence;

3) Correction of the observed harmonics;

4) Correction of the measurement signals; and

5) Determination of at least one of the rotor position and speed.

These steps are detailed in the rest of the description. The steps can be carried out by a computer system or an electronic system, notably a computer or electronic system that controls the electric machine.

FIG. 2 schematically illustrates, by way of non-limitative example, the steps of the method according to the second embodiment of the invention. Position sensor CAP first generates measurement signals y. The harmonics of the measurements are then determined by use of a closed loop BF, which comprises a harmonic state observer OBS, a phase difference corrector CORD and a first phase-locked loop PLL1. Harmonic state observer OBS determines the harmonics H from measurement signals y and from the rotor position Gobs estimated by first phase-locked loop PLL1. Harmonic state observer OBS also determines signals y_hf formed by the suppression of the harmonics of order strictly greater than 1 from measurement signals y. Phase difference corrector CORD identifies and corrects the phase difference, as well as the offset and the amplitudes of measurement signals y_hf to form a corrected signal yd from the identified harmonics. First phase-locked loop PLL1 estimates an estimated rotor position Gobs from corrected signal yd. Furthermore, the method according to the invention comprises a step of correcting the harmonics COROBS if the convergence C of harmonic state observer OBS is ensured. The corrected harmonics are denoted by Hc. Besides, the method according to the invention comprises a step of suppressing harmonics CORH of measurement signal y from the determined corrected harmonics Hc. The corrected signal is denoted by yc. In addition, the method according to the invention comprises a second phase-locked loop PLL2 that estimates the position \hat{θ} of at least one of the rotor and the speed \hat{ω} of the rotor from signal yc. According to an embodiment of the invention, the method can further comprise feedback of position \hat{θ} estimated by second phase-locked loop PLL2 for correction of the harmonics CORH. For this second embodiment, at least one of the estimated rotor position and speed are obtained by second phase-locked loop PLL2.

1) Determination of Harmonics

This step determines the harmonics of the measurement signals generated by the position sensor using a closed loop. A closed loop is understood to be a succession of steps wherein one output of the steps is also used as input for at least one other step that precedes it. In other words, the closed loop comprises at least one feedback.

The closed loop comprises:

a harmonic state observer that relates the measurement signals and the estimated rotor position to the measurement signal harmonics, and filters from the measurement signals the harmonics of order strictly greater than 1;

a phase difference corrector that identifies and corrects the amplitude, the offset and the phase of the filtered measurement signals by use of the harmonics of order less than or equal to 1, determined by the harmonic state observer;

a first phase-locked loop that estimates the position of the rotor from the corrected signals; and

a feedback of the position estimated by the first phase-locked loop to an input of the harmonic state observer.

A state observer is an extension of a model represented as a state representation. When the state of a system is not measurable, an observer allowing the state to be reconstructed from a model of the dynamic system and measurements of other quantities is designed.

A phase-locked loop (PLL) is an electronic or computer assembly allowing locking the phase or the output frequency of a system to the phase or the frequency of the input signal. It can also lock an output frequency to a multiple of the input frequency. The first phase-locked loop provides better harmonic identification.

According to an embodiment of the invention, the harmonic state observer can use, for each harmonic of order k, a transfer function of the form:

$$\frac{{\hat{y}}_{k}}{y} = \frac{\frac{α * s}{{s}^{2} + {( k * ω )}^{2}}}{1 + {\sum }_{k = 0 \to n} \frac{α * s}{{s}^{2} + {( k * ω )}^{2}}}$$

with s being the Laplace parameter, a being a state observer gain, k being the order of the harmonic considered, n being the number of harmonics of the measurement signals, w being the fundamental frequency with θ=ω*t, θ being the angular position, y being the generated signal considered among the cosine and sine signal, and ŷₖ being the estimated harmonic of order k of the generated signal considered among the cosine and sine signal.

Advantageously, state observer gain a can be determined to be less than fundamental frequency ω. Preferably, state observer gain a can be less than one tenth of fundamental frequency ω. Gain a allows adjusting the convergence of the harmonic state observer. According to an embodiment example, gain a can be 10. This value provides fast convergence without significant deformation of the observed signal.

According to an embodiment, the transfer function can be determined by use of the following operations:

The measurement signals, denoted by ya and yb respectively, which contain the harmonics, can be written as follows:

yₐ=L₀ₐ+L₁ₐ sin(θ)+L₂ₐ sin(2θ+ϕₐ₂)+L₃ₐ sin(3θ+ϕ_{α2})+ . . . +Lₙₐ sin(nθ+ϕₐₙ)

y_{b}=L_{0b}+L_{1b} cos(θ+ϕ)+L_{2b} sin(2θ+ϕ_{b2})+L_{3b} sin(3θ+ϕ_{b2})+ . . . +L_{nb} sin(nθ+ϕ_{bn})

or:

yₐ=L₀ₐ+L₁₁ₐ sin(θ)+L₁₂ₐ cos(θ)+L₂₁ₐ sin(2θ)+L₂₂ₐ cos(2θ)+L₃₁ₐ sin(3θ)+L₃₂ₐ cos(3θ)+ . . . +Lₙ₁ₐ sin(nθ)+Lₙ₂ₐ cos(nθ)

y_{b}=L_{0b}+L_{11b} sin(θ)+L_{12b} cos(θ)+L_{21b} sin(2θ)+L_{22b} cos(2θ)+L_{31b} sin(3θ)+L_{32b} cos(3θ)+ . . . +L_{n1b} sin(nθ)+L_{n2b} cos(nθ)

In these equations and in the rest of the description, subscript a designates the first measurement signal (the cosine signal for example) and subscript b designates the second measurement signal (the sine signal for example). In these equations, θ=ω*t, with ω being the fundamental frequency, L11a, L12a, L11b, L12b being the fundamental coefficients of the measurement signals (that is the coefficients related to the fundamental of the harmonics), Li1a, Li2a, Li1b, Li2b (with i ranging between 2 and n, n being the harmonic of highest frequency being considered) being the coefficients of the harmonics of the measurement signals, L0a and L0a being the offsets of the measurement signals (i.e. the continuous offsets).

To simplify this writing, the vectors can be denoted by L and W (without subscripts a and b):

L=[L₀L₁₁L₁₂L₂₁L₂₂ . . . Lₙ₁Lₙ₂]^{T},

W=[1 sin(θ)cos(θ)sin(2θ)cos(2θ) . . . sin(nθ)cos(nθ)]^{T}

and the vector of the estimation of coefficients L can be defined as follows:

\hat{L}=[ [symbol] [symbol] [symbol] [symbol] [symbol] . . . [symbol] [symbol] ]^{T}

It can be written:

y=L^{T}*W, et ŷ=\hat{L}^{T}*W

According to the following documents:
Osowski, S. (1992). Neural Network for Estimation of Harmonic Components in a Power System. IEEE Generation, Transmission and Distribution, (pp. 129-135), and
Siyu Leng, W. L.-Y. (2009). Active Power Filter for Three-Phase Current. IEEE American Control Conference, (pp. 2140-2147). MO, USA,
   it can be written:

\hat{L}=P*(y−ŷ)*W

where P is the diagonal matrix of dimension (2n+1)*(2n+1) defined by:

P=diag(α)

with α the state observer gain.

The estimator of coefficients L can then be written as follows:

[symbol]

=α*(y−ŷ)

[symbol]

=α*(y−ŷ)*sin(θ)

[symbol]

=α*(y−ŷ)*cos(θ)

[symbol]

=α*(y−ŷ)*sin(2θ)

[symbol]

=α*(y−ŷ)*cos(2θ)

. . .

[symbol]

=α*(y−ŷ)*sin(nθ)

[symbol]

=α*(y−ŷ)*cos(nθ)

The estimation of the fundamental part denoted by ŷ_{f} can be extracted from these equations by removing the harmonics denoted by ŷₕ and the offsets denoted by ŷ_{offset}:

ŷ_{f}=y−ŷₕ−ŷ_{offset}

o\dot{u}= [symbol] et ŷₕ=Σᵢ₌₂ⁿ( [symbol] sin(iθ)+ [symbol] cos(iθ))

Using the Laplace transform to form the following equation:

y(t)−ŷ(t)=y(t)−Σₖ₌₀ⁿ(ŷₖ(t))o\dot{u}yₖ(t)=(\hat{L}ₖ₁ sin(k*θ)+\hat{L}ₖ₂ cos(k*θ))

with k the harmonic order number. We can then write:

$$y ( s ) - \hat{y} ( s ) = y ( s ) - {\sum }_{k = 0 \to n} {\hat{y}}_{k} ( s )$$

with

ŷₖ= [symbol] (\hat{L}ₖ₁ sin(k*θ))+ [symbol] (\hat{L}ₖ₂ cos(k*θ))

with [symbol] the Laplace transform.

it can be written:

$${\hat{y}}_{k} ( s ) = ( y ( s ) - \hat{y} ( s ) ) * \frac{α * s}{{s}^{2} + {( k * ω )}^{2}}$$

The transfer function can then be written for each harmonic of order k:

$$\frac{{\hat{y}}_{k}}{y} = \frac{\frac{α * s}{{s}^{2} + {( k * ω )}^{2}}}{1 + {\sum }_{k = 0 \to n} \frac{α * s}{{s}^{2} + {( k * ω )}^{2}}}$$

For fundamental (k=1), the transfer function between fundamental ŷ_{f} and measurement y can be written:

$$H ( s ) = \frac{{\hat{y}}_{f} ( s )}{y ( s )} = \frac{1 + \frac{α * s}{{s}^{2} + {ω}^{2}}}{1 + {\sum }_{k = 0 \to n} \frac{α * s}{{s}^{2} + {( k * ω )}^{2}}}$$

According to an implementation of the invention, the harmonic state observer can further determine the fundamental coefficients of the harmonics and the offsets of the measurement signals.

According to an embodiment, for the phase difference correction step, the phase difference between the measurement signals, preferably between the fundamentals of the measurement signals, can be identified by use of the fundamental coefficients of the harmonics. This phase difference identification can be carried out by use of an arctangent function.

Advantageously, phase difference ϕ between the fundamentals of the measurement signals can be determined by the equations:

$$ϕ = atan ( \frac{{L}_{1 b} * sin ( ϕ )}{{L}_{1 b} * cos ( ϕ )} )$$

$$using$$

$${L}_{1 b} * sin ( ϕ ) = - {\hat{L}}_{11 b} * cos ( Δθ ) - {\hat{L}}_{12 b} * sin ( Δθ )$$

$${L}_{1 b} * cos ( ϕ ) = {\hat{L}}_{12 b} * cos ( Δθ ) - {\hat{L}}_{11 b} * sin ( Δθ )$$

with L_{1b} being the fundamental coefficient of one of the generated cosine and sine signals, \hat{L}_{11b} and \hat{L}_{12b} being the fundamental coefficients determined by the harmonic state observer, AO being the difference between the measured rotor position and the rotor position estimated by the first phase-locked loop PLL.

Indeed, for this step, the following operations can be carried out:

With the hypothesis ŷ_{fa}=yₐ and if ŷ_{fa}=yₐ (subscript f denotes the fundamental), it can be written by the following equations:

\hat{L}₁₁ₐ sin(\hat{θ})+\hat{L}₁₂ₐ cos(\hat{θ})=L₁ₐ*sin(θ).

\hat{L}_{11b} sin(\hat{θ})+\hat{L}_{12b} cos(\hat{θ})=L_{1b}*cos(θ+ϕ)

with \hat{θ} the estimated value of the rotor position (corresponding to θ_{obs} in FIG. 1 or FIG. 2). Fundamental signal coefficients Lₐ and L_{b} can be calculated by the following equations:

L_{1α}=\sqrt{\hat{L}₁₁ₐ²+\hat{L}₁₂ₐ²},L_{1b}=\sqrt{\hat{L}_{11b}²+\hat{L}_{12b}²}

By putting θ=\hat{θ}+Δθ, it can be written:

$${L}_{1 a} * sin ( θ ) = {L}_{1 a} * sin ( \hat{θ} + Δ θ ) = {L}_{1 a} * sin ( \hat{θ} ) * cos ( Δ θ ) + {L}_{1 a} * cos ( \hat{θ} ) * sin ( Δθ ) , et$$

$$\begin{matrix}{L}_{1 b} * cos ( θ + ϕ ) = {L}_{1 b} * cos ( \hat{θ} + Δθ + ϕ ) \\ = {L}_{1 b} * cos ( \hat{θ} ) * cos ( Δθ + ϕ ) - {L}_{1 b} * sin ( \hat{θ} ) * sin ( Δθ + ϕ )\end{matrix}$$

it can be obtained:

\hat{L}₁₁ₐ=L₁ₐ*cos(Δθ),\hat{L}₁₂ₐ=L₁ₐ*sin(Δθ)

\hat{L}_{11b}=−L_{1b}*sin(Δθ+ϕ),\hat{L}_{12b}=L_{1b}*cos(Δθ+ϕ)

From these equations, we can show that:

$$cos ( Δθ ) = \frac{{\hat{L}}_{11 a}}{{L}_{1 a}} , \qquad sin ( Δθ ) = \frac{{\hat{L}}_{12 a}}{{L}_{1 a}}$$

$${L}_{1 b} * sin ( ϕ ) = - {\hat{L}}_{11 b} * cos ( Δθ ) - {\hat{L}}_{12 b} * sin ( Δθ ) .$$

$${L}_{1 b} * cos ( ϕ ) = - {\hat{L}}_{12 b} * cos ( Δθ ) - {\hat{L}}_{11 b} * sin ( Δθ )$$

By injecting the last two equations, phase difference 1 can be identified in the following equation:

$$ϕ = atan ( \frac{{L}_{1 b} * sin ( ϕ )}{{L}_{1 b} * cos ( ϕ )} )$$

One of the two measurement signals can be corrected from the identified phase difference to eliminate the phase difference. A signal without phase difference can therefore be reconstructed by use of the values determined for the fundamentals of the harmonics of the measurement signals, the values of the fundamental coefficients and the identified phase difference angle.

According to an embodiment of the invention, the phase difference of one of the measurement signals is corrected by use of the equation:

$${y}_{fb - correction} = {L}_{1 b} * \frac{{y}_{fb} - \frac{{y}_{fa}}{{L}_{1 a}} * ( {L}_{1 b} * sin ( ϕ ) )}{( {L}_{1 b} * cos ( ϕ ) )}$$

with y_{fb-correction} the fundamental of the measurement signal considered, L₁ₐ and L_{1b} the fundamental coefficients of the measurement signals, y_{fa} and y_{fb} the fundamentals of the measurement signals, and ϕ the phase difference.

Indeed, by definition:

y_{fa}=L₁ₐ*sin(θ),y_{fb}=L_{1b}*cos(θ+ϕ)

and it is desired to establish the corrected fundamental signal defined by:

y_{fb-correction}=L_{1b}*cos(θ)

If we use the following development:

$$cos ( θ ) = \frac{cos ( θ + ϕ ) - sin ( θ ) * sin ( ϕ )}{cos ( ϕ )}$$

it can be obtained:

$${y}_{fb - correction} = \frac{{L}_{1 b} * cos ( θ + ϕ ) - {L}_{1 b} * sin ( θ ) * sin ( ϕ )}{cos ( ϕ )}$$

By replacing with the definition of the fundamental signals, we can have:

$${y}_{fb - correction} = {L}_{1 b} * \frac{{y}_{fb} - \frac{{y}_{fa}}{{L}_{1 a}} * ( {L}_{1 b} * sin ( ϕ ) )}{( {L}_{1 b} * cos ( ϕ ) )}$$

According to an embodiment of the invention, the first phase-locked loop can notably comprise a proportional integral controller and an integrator.

Preferably, the first phase-locked loop can be in accordance with the embodiment of FIG. 3. For this embodiment, the first phase-locked loop comprises as the input a sine signal sin(θ) and a cosine signal −cos(θ). Sine signal sin(θ) is multiplied by a signal corresponding to the cosine of the angular position \hat{θ} (for this step, \hat{θ} corresponds to Gobs of FIGS. 1 and 2) estimated by the output of the first phase-locked loop. Cosine signal −cos(θ) is multiplied by a signal corresponding to the sine of the angular position \hat{θ} estimated by the output of the first phase-locked loop. The outputs of the multipliers are then added together. A signal ϵ corresponding to sin(θ)×cos(\hat{θ})−cos(θ)×sin(\hat{θ}), which is equal to sin(θ−\hat{θ}), is thus obtained. Signal ϵ is then passed through a proportional integral PI controller for estimating the rotational speed of the rotor \hat{ω}. The PI controller comprises a proportional coefficient denoted by Kp and an integral coefficient Ki. This signal is subsequently integrated in an integrator, which corresponds to the 1/s function in the Laplace domain, to estimate rotor position \hat{θ}.

For this embodiment, the transfer function of the first phase-locked loop can be written:

$$\frac{\hat{θ} ( s )}{θ ( s )} = \frac{1 + \frac{{K}_{p}}{{K}_{i}} * s}{1 + \frac{{K}_{p}}{{K}_{i}} * s + \frac{1}{{K}_{i}} * {s}^{2}}$$

with θ being the rotor position, \hat{θ} being the rotor position estimated by the first phase-locked loop, s being the Laplace parameter, Kₚ being the proportional coefficient of the proportional integral controller and Kᵢ being the integral coefficient of the proportional integral controller.

Indeed, the first phase-locked loop allows the following relation to be written:

$$\hat{θ} ( s ) = \frac{1}{s} * ( {K}_{p} + \frac{{K}_{i}}{s} ) * ϵ ( s )$$

By use of a linear approximation such as:

ϵ=sin(θ−\hat{θ})≈θ−\hat{θ}

the following equation can be obtained:

$$\hat{θ} ( s ) = \frac{1}{s} * ( {K}_{p} + \frac{{K}_{i}}{s} ) * ( θ ( s ) - \hat{θ} ( s ) )$$

which allows the above transfer function to be obtained.

According to an aspect of the invention, coefficients Kp and Ki verify the following inequations Kp>0 and Ki>0 for the phase-locked loop to be stable.

The natural frequency of the phase-locked loop ω_{PLL} is ω_{PLL}=\sqrt{Kᵢ}.

For a good performance of the phase-locked loop, coefficients Kp and Ki are determined so that the quality factor mPLL as defined below is close to 1.

$${m}_{PLL} = \frac{{ω}_{PLL}}{2} * \frac{{K}_{p}}{{K}_{i}}$$

For the first embodiment, the at least one of the estimated rotor position and/or speed are obtained by the first phase-locked loop.

For the second embodiment, steps 2) to 5) described hereafter are carried out.

2) Determination of the Harmonic Observer Convergence

This step determines the convergence of the harmonic state observer of the closed loop, to activate correction of the harmonics only if the harmonic state observer is convergent. Thus, only good harmonic estimations are kept and corrections based on non-converged values are avoided, which prevents inaccuracies and at least one of rotor position and speed determination errors. Thus, determination of the position and/or the rotational speed of the rotor is improved.

The convergence of the harmonic state observer can be determined using any means.

According to an embodiment of the invention, the convergence of the harmonic state observer can be determined by use of the following equation:

\sqrt{|yₐ−ŷₐ|²+|y₀−ŷ_{b}|²}<ε

with ϵ being a predetermined threshold, yₐ and y_{b} being the measurement signals, and ŷₐ and ŷ_{b} being the estimated signals reconstructed from the harmonics determined by the harmonic state observer and the position determined by the first phase-locked loop.

According to an embodiment of the invention, the observer convergence can be determined when the above equation is verified over a constant or variable time interval, over one or more electrical revolutions for example.

3) Correction of the Observed Harmonics

This step corrects the harmonics observed by use of the first phase-locked loop in order to synchronize them with the second phase-locked loop. Generally, the electrical positions of the two phase-locked loops differ by a quantity denoted by Δθ_{PLL}. The reference position, denoted by θ here, is estimated by the second phase-locked loop, whose kinematics is faster than that of the first phase-locked loop. The observer is considered to be convergent. We then have, for example for the sine signal denoted by a:

ŷₖₐ=yₖₐ

\hat{L}ₖ₁ₐ_{_{PLL1}}=\hat{L}ₖ₁ₐ_{_{PLL1}} cos(kΔθ_{PLL})+\hat{L}ₖ₂ₐ_{_{PLL1}} sin(kΔθ_{PLL})

\hat{L}ₖ₁ₐ_{_{PLL1}}sin ( [symbol] ) +\hat{L}ₖ₂ₐ_{_{pLL1}}cos( [symbol] )=Lₖₐ*sin(kΔθ+ϕₐₖ).

The values of the harmonics associated with the second phase-locked loop are sought:

\hat{L}ₖ₁ₐ_{_{PLL2}}=Lₖₐ*cos(ϕₐₖ) and \hat{L}ₖ₂ₐ_{_{PLL2}}=Lₖₐ*sin(ϕₐₖ)

The following values are calculated:

\hat{L}ₖ₁ₐ_{_{PLL2}}=\hat{L}ₖ₁ₐ_{_{PLL1}} cos(kΔθ_{PLL})+\hat{L}ₖ₂ₐ_{_{PLL1}} sin(kΔθ_{PLL})

\hat{L}ₖ₂ₐ_{_{PLL2}}=\hat{L}ₖ₂ₐ_{_{PLL1}} cos(kΔθ_{PLL})−\hat{L}ₖ₁ₐ_{_{PLL1}} sin(kΔθ_{PLL})

It is noted that the above calculation is for each harmonic, of a compensatory rotation of the harmonics observed, by an angle equal to the angle difference observed by the two phase-locked loops multiplied by the order of the harmonic considered.

According to an embodiment of the invention, quantity Δθ_{PLL} can be determined as described hereafter. It should be noted the definition (y₁ₐ is the phase reference of the system) is included:

y₁ₐ=L₁₁ₐ*sin(θ)

Therefore, L₁₂ₐ is 0 by definition, as well as ϕₐ₁.

The equation \hat{L}ₖ₂ₐ_{_{PLL1}}=Lₖₐ*sin(kΔθ_{PLL}+ϕₐₖ) is applied to harmonic 1, the result is: \hat{L}₁₂ₐ_{_{PLL1}}=Lₖₐ*sin(Δθ_{PLL}), and similarly: \hat{L}₁₁ₐ_{_{PLL1}}=Lₖₐ*cos(Δθ_{PLL}), from which calculates possible of Lₖₐ and Δθ_{PLL}.

4) Correction of the Measurement Signals

This step continuously corrects the measurement signals to eliminate the effects of the harmonics determined in step 1) and corrected in step 3), only when the harmonic state observer has been determined convergent in step 2). In other words, correction of the measurement signals is activated when the harmonic state observer provides reliable observations.

When the harmonic state observer is not convergent, the measurement signals are corrected by the last harmonic values observed when the observer was convergent, and the signals are used in step 5).

According to an embodiment of the invention, the measurement signals can be continuously corrected by filtering the harmonics determined in steps 1) and 3).

Filtering the harmonics in the measurement signals is obtained with:

y_{c}=y−L₀ₐ−L₂₁ₐ sin(2θ)−L₂₂ₐ cos(2θ)−L₃₁ₐ sin(3θ)−L₃₂ₐ cos(3θ)− . . . −Lₙ₁ₐ sin(nθ)−Lₙ₂ₐ cos(nθ)

According to an embodiment of the invention, the phase difference, the amplitude and the offset of signals y_{c} can then be corrected by a method identical to that used in step 1).

5) Determination of the Rotor Position and/or Speed

This step determines at least one of the position and the speed of the rotor by a second phase-locked loop from the corrected measurement signals when the harmonic state observer is convergent (at the end of step 3), and from the uncorrected measurement signals when the harmonic state observer is divergent.

The second phase-locked loop can have the same structure as the first phase-locked loop (according to FIG. 3). The constituent elements and the transfer function are identical to those described in step 1. However, the coefficients of the PI controller may be different. In particular, integral coefficient Ki of the first phase-locked loop may be less than integral coefficient Ki of the second phase-locked loop. Integral coefficient Ki of the first phase-locked loop can be related to the resonance of the mechanical system, while integral coefficient Ki of the second phase-locked loop can depend on the electrical bandwidth. The first phase-locked loop thus has slower kinematics than the second phase-locked loop.

Furthermore, the invention relates to a method of controlling an electric machine, the electric machine comprising a sensor for determining the angular position of the rotor of the electric machine. The position sensor generates a cosine signal and a sine signal. The control method comprises the following steps:

a) determining at least one of the position and the speed of the rotor by the method of determining at least one of the rotor position and speed according to any one of the variants or variant combinations described above, the method being applied to the measurement signals of the position sensor, and

b) controlling the electric machine according to the determined at least one of position and speed.

According to an embodiment of the invention, the torque or the rotational speed of the electric machine can notably be controlled.

The invention further relates to a method of monitoring an electric machine, the electric machine comprising a sensor for determining the angular position of the rotor of the electric machine. The position sensor generates a cosine signal and a sine signal. The monitoring method comprises the following steps:

a) determining at least one of the position and the speed of the rotor by the method of determining at least one of the rotor position and speed according to any one of the variants or variant combinations described above, the method being applied to the measurement signals of the position sensor, and

b) monitoring the electric machine according to the determined at least one of position and speed.

According to an embodiment of the invention, the monitoring method can comprise a step of diagnosis of abnormal electric machine operation. In this case, the monitoring method can comprise an electric machine control step in order to take account of the abnormal operation of the electric machine. For example, control in case of abnormal electric machine operation can stop the electric machine.

It is clear that the invention is not limited to the embodiments of the steps described above by way of example and that it encompasses all variant embodiments.

### Examples

The features and advantages of the method according to the invention will be clear from reading the application example hereafter.

This example simulates the method of determining the position and the speed of the rotor according to the second embodiment of the invention. For this simulation, theoretical measurement signals are considered of the form:

y_{α}=0.95*sin(ωt)+0.05+0.09*sin(2ωt)−0.04*cos(2ωt)+0.02*sin(3ωt)+wₐ,

y_{b}=1.05*cos(ωt+ϕ)+0.03−0.086*sin(2ωt)+0.051*cos(2ωt)−−0.025*cos(3ωt)+w_{b},

For this example, the value of fundamental phase difference ϕ is 3°, the noises are denoted by wa and wb, and the gain of the harmonic state observer a is 10.

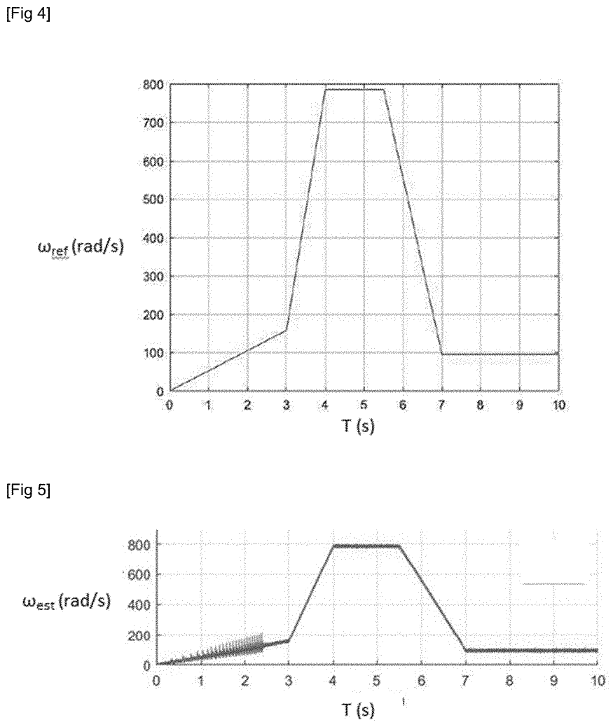

FIG. 4 illustrates the evolution of reference rotational speed ωref in rad/s as a function of time T in s for the simulation. The rotational speed ωref considered comprises five phases: a first phase between 0 and 3 s with a slight increase in rotational speed ωref, a second phase between 3 and 4 s with a sharp increase in rotational speed ωref, a third phase between 4 and 5.5 s of stability of rotational speed ωref, a fourth phase between 5.5 and 7 s of sharp decrease in rotational speed ωref, and a fifth phase between 7 and 10 s of stability of rotational speed ωref.

For the simulation, the two phase-locked loops according to the structure illustrated in FIG. 3 are used. For the first phase-locked loop, a natural frequency ωPLL of 60 rad/s is selected, which implies an integral coefficient Ki of 3600. For the second phase-locked loop, a natural frequency ωPLL of 400 rad/s is selected, which implies an integral coefficient Ki of 160,000. For the first phase-locked loop, the value of proportional coefficient Kp is 120. For the second phase-locked loop, the value of proportional coefficient Kp is 800. Thus, for each phase-locked loop, the value of quality factor mPLL is 1.

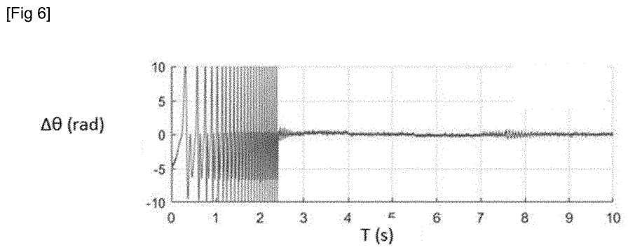

For this example, FIG. 5 illustrates the rotational speed ωest in rad/s estimated with the method according to the invention as a function of time T in s, at the output of the second phase-locked loop. FIG. 6 illustrates difference Δθ in rad between the angle estimated by the method according to the invention and the reference angle as a function of time T in s, at the output of the second phase-locked loop. It is first observed that the estimated speed is similar to the reference speed. It is also noted that, in the low-speed zone (up to about 85 rad/s), the harmonic observer is not activated yet, there is therefore a large estimation error. However, as soon as the rotational speed reaches the threshold of 85 rad/s (which substantially corresponds to \sqrt{2} times the natural frequency of the first phase-locked loop), the harmonic observer is operating, which implies convergence of the harmonic observer, which in turn provides good speed and position estimations by the second phase-locked loop. In particular, from the second phase to the fifth phase, the speed and position estimations remain reliable. It is also noted that, when the rotational speed decreases (fourth phase), the speed and position estimation remains good, although the rotational speed is less than \sqrt{2} times the natural frequency of the second phase-locked loop.

The method according to the invention therefore allows to precisely and reliably determine the position and the rotational speed of the rotor of an electric machine.

1. A method of determining the position and/or the speed of a rotor of an electric machine by means of a sensor (CAP) that determines the position of said rotor, said position sensor (CAP) generating a cosine signal and a sine signal, characterized in that the method utilizes a closed loop (BF) comprising a harmonic state observer (OBS), correction of said phase difference (CORΦ) of said generated cosine and sine signals, and a first phase-locked loop (PLL1), said state observer of said harmonics (OBS) relating said generated cosine and sine signals and a value of said rotor position (θ_{obs}) estimated by said first phase-locked loop (PLL1) to said harmonics, said correction of a phase difference (CORΦ) identifying and correcting the phase difference of said generated cosine and sine signals by means of said harmonics determined by said state observer of said harmonics (OBS), and said first phase-locked loop (PLL1) estimating the position and/or the speed of said rotor from said corrected cosine and sine signals.

2. A method of determining the position and/or the speed of a rotor as claimed in claim 1, wherein the following steps are carried out:
a) determining the harmonics of said generated cosine and sine signals by means of said harmonic state observer (OBS) of said closed loop (BF) comprising said state observer of said harmonics (OBS), said correction of said phase difference (CORΦ) of said generated cosine and sine signals, and said first phase-locked loop (PLL1),
b) determining whether said state observer (OBS) of said harmonics is convergent,
c) continuously correcting said generated cosine and sine signals (CORH) by updating said determined harmonics when said state observer of said harmonics is convergent, and
d) determining said position and/or said speed of said rotor by means of a second phase-locked loop (PLL2) from said corrected cosine and sine signals.

3. A method of determining the position and/or the speed of a rotor as claimed in claim 2, wherein the convergence of said state observer (OBS) of said harmonics is determined by verifying the equation:
\sqrt{|yₐ−ŷₐ|²+|y_{b}−ŷ_{b}|²}<ε
with yₐ and y_{b} said generated cosine and sine signals respectively, ŷₐ and ŷ_{b} the signals reconstructed by means of an estimated position, and ε a predetermined threshold.

4. A method of determining the position and/or the speed of a rotor as claimed in claim 2, wherein said first and second phase-locked loops (PLL1, PLL2) comprise a proportional integral (PI) controller and an integrator.

5. A method of determining the position and/or the speed of a rotor as claimed in claim 4, wherein the transfer function of said first and second phase-locked loops PLL is written as follows:
$$\frac{\hat{θ} ( s )}{θ ( s )} = \frac{1 + \frac{{K}_{p}}{{K}_{i}} * s}{1 + \frac{{K}_{p}}{{K}_{i}} * s + \frac{1}{{K}_{i}} * {s}^{2}}$$
with θ the position of said rotor, \hat{θ} the estimated position of said rotor, s the Laplace parameter, Kₚ the proportional coefficient of said proportional integral controller and Kᵢ the integral coefficient of said proportional integral controller.

6. A method of determining the position and/or the speed of a rotor as claimed in claim 5, wherein said integral coefficient Kᵢ of said first phase-locked loop (PLL1) is less than said integral coefficient Kᵢ of said second phase-locked loop (PLL2).

7. A method of determining the position and/or the speed of a rotor as claimed in claim 2, wherein said cosine and sine signals are corrected (CORH) by filtering said determined harmonics and possibly by correcting the phase difference of said cosine and sine signals.

8. A method of determining the position and/or the speed of a rotor as claimed in claim 1, wherein said state observer (OBS) of said harmonics involves a transfer function:
$$\frac{{\hat{y}}_{k}}{y} = \frac{\frac{α * s}{{s}^{2} + {( k * ω )}^{2}}}{1 + {\sum }_{k = 0 \to n} \frac{α * s}{{s}^{2} + {( k * ω )}^{2}}}$$
with s the Laplace parameter, α a gain, k an order of the harmonic considered, n a number of harmonics of said cosine and sine signals, ω the fundamental frequency, y the generated signal considered among the cosine and sine signal, and ŷₖ the estimated harmonic of order k of said generated signal considered among the cosine and sine signal.

9. A method of determining the position and/or the speed of a rotor as claimed in claim 8, wherein said gain α is less than said fundamental frequency, preferably said gain a is less than one tenth of said fundamental frequency ω.

10. A method of determining the position and/or the speed of a rotor as claimed in claim 8, wherein said state observer (OBS) of said harmonics further determines fundamental coefficients of said harmonics and said offsets of said generated cosine and sine signals.

11. A method of determining the position and/or the speed of a rotor as claimed in claim 10, wherein said phase difference between said generated cosine and sine signals is identified by means of said fundamental coefficients of said harmonics using an arctangent function.

12. A method of determining the position and/or the speed of a rotor as claimed in claim 11, wherein said phase difference Φ between said generated cosine and sine signals is determined by means of the equation:
$$ϕ = atan ( \frac{{L}_{1 b} * sin ( ϕ )}{{L}_{1 b} * cos ( ϕ )} )$$
$$with$$
$${L}_{1 b} * sin ( ϕ ) = - {\hat{L}}_{11 b} * cos ( Δθ ) - {\hat{L}}_{12 b} * sin ( Δθ )$$
$${L}_{1 b} * cos ( ϕ ) = - {\hat{L}}_{12 b} * cos ( Δθ ) - {\hat{L}}_{11 b} * sin ( Δθ )$$
and with L_{1b} a fundamental coefficient of one of said generated cosine and sine signals, \hat{L}_{11b} and \hat{L}_{12b} fundamental coefficients determined by said state observer of said harmonics, Δθ a difference between the measured position of said rotor and the position of said rotor estimated by said first phase-locked loop (PLL1).

13. A method of determining the position and/or the speed of a rotor as claimed in claim 1, wherein said phase difference (CORΦ) of one of said generated cosine and sine signals is corrected by means of the equation:
$${y}_{fb - correction} = {L}_{1 b} * \frac{{y}_{fb} - \frac{{y}_{fa}}{{L}_{1 a}} * ( {L}_{1 b} * sin ( ϕ ) )}{( {L}_{1 b} * cos ( ϕ ) )}$$
with y_{fb-correction} the fundamental of said corrected generated signal of one of said generated cosine and sine signals, L₁ₐ and L_{1b} the fundamental coefficients of said generated cosine and sine signals respectively, y_{fa} and y_{fb} the fundamentals of said measured generated cosine and sine signals respectively, and Φ said phase difference.

14. A method of determining the position and/or the speed of a rotor as claimed in claim 1, wherein said position sensor is a magnetostrictive sensor, an inductive sensor, an encoder, a GMR sensor, an AMR sensor, a TMR sensor or a solver.

15. A method of controlling an electric machine, said electric machine comprising a sensor that determines the position of the rotor of said electric machine, said position sensor generating a cosine signal and a sine signal, wherein the following steps are carried out:
a) determining said position and/or said speed of said rotor by means of said method as claimed in any one of the previous claims and said signals generated by said position sensor, and
b) controlling said electric machine according to said predetermined position and/or speed.
